(19) United States
(12) Patent Application Publication
(10) Pub. No.: US 2013/0117357 A1
(43) Pub. Date: May 9, 2013

(54) CONTROL DEVICE, CONTROL TARGET DEVICE AND METHOD OF TRANSMITTING CONTENT INFORMATION THEREOF

(71) Applicants: Seungryul Yang, Seoul (KR); Hyeoncheol Cho, Seoul (KR); Youngwook Kang, Seoul (KR); Minsoo Lee, Seoul (KR); Jongyeop Lee, Seoul (KR); Jangwoong Park, Seoul (KR); Beomjin Jeon, Seoul (KR); Yoonsik Uhm, Seoul (KR); Kwangsung Ha, Seoul (KR); Jaeni Jang, Seoul (KR); Youngjun Jo, Seoul (KR); Seungchul Han, Seoul (KR); Youngkyun Jin, Seoul (KR)

(72) Inventors: Seungryul Yang, Seoul (KR); Hyeoncheol Cho, Seoul (KR); Youngwook Kang, Seoul (KR); Minsoo Lee, Seoul (KR); Jongyeop Lee, Seoul (KR); Jangwoong Park, Seoul (KR); Beomjin Jeon, Seoul (KR); Yoonsik Uhm, Seoul (KR); Kwangsung Ha, Seoul (KR); Jaeni Jang, Seoul (KR); Youngjun Jo, Seoul (KR); Seungchul Han, Seoul (KR); Youngkyun Jin, Seoul (KR)

(21) Appl. No.: 13/670,984

(22) Filed: Nov. 7, 2012

Related U.S. Application Data
(60) Provisional application No. 61/557,376, filed on Nov. 8, 2011.
(60) Provisional application No. 61/557,916, filed on Nov. 10, 2011.
(60) Provisional application No. 61/563,819, filed on Nov. 27, 2011.

(51) Int. Cl. G06F 15/16

(52) U.S. Cl. 709/203

(57) ABSTRACT

A method of controlling a control device and a server is provided. The method of transmitting content information, the method comprising: transmitting an aggregation mode obtaining action to a media server; receiving information on the aggregation mode corresponding to the service description request signal transmitted from the media server; determining whether the media server perform an aggregation function using the information on an aggregation mode.

### CROSS-REFERENCE TO RELATED APPLICATIONS

The present application claims priority under 35 U.S.C. 119 and 35 U.S.C. 365 to U.S. Patent Application No. 61/557,376 (filed on Nov. 8, 2011), U.S. Patent Application No. 61/557,916 (filed on Nov. 10, 2011) and U.S. Patent Application No. 61/563,819 (filed on Nov. 27, 2011), which is hereby incorporated by reference in its entirety.

### BACKGROUND

The present invention relates to a method of controlling a control device and a server, and more particularly, to a method of controlling an aggregation function of a server.

A universal plug and play (UPnP) technology and a digital living network alliance (DLNA) technology allow services and controls between home appliances of various manufactures. Especially, the UPnP technology allows compatible AV services and controls between audio-video (AV) devices. These compatible AV services include media streaming, uploading, and downloading.

The DLNA, as a home network device, includes a digital media server (DMS), a digital media player (DMP), a digital media renderer (DMR), a digital media controller (DMC), and a digital media printer (DMPr), and, as a mobile portable device, includes a mobile digital media server (M-DMS), a mobile digital media player (M-DMP), a mobile digital media uploader (M-DMU), a mobile digital media downloader (M-DMD), and a mobile digital media controller (M-DMC). Hereinafter, a digital media server (DMS) conceptually includes the M-DMS; a digital media player (DMP) conceptually includes the M-DMP; and a digital media controller (DMC) conceptually includes the M-DMC.

The UPnP classifies such devices into control point (CP) devices and control target devices. The DMC and DMP may be classified into a control point device, and the DMR, DMS, and DMPr may be classified into a control target device.

Moreover, the DLNA may define a 2 Box Model and a 3 Box Model.

The 2 Box Model includes a DMP and a DMS. In the 2 Box Model, the DMP allows a user to search for and play contents browsed and distributed by the DMS.

The 3 Box Model includes a DMC, a DMS, and a DMR. In the 3 Box Model, the DMC allows a user to search for the contents of the DMS, which are to be played in the DMR.

When a CP device of the UPnP or a DMP and DMC of the DLNA request content metadata to a control target device of the UPnP or a DMS of the DLNA, the control target device or the DMS collects a plurality of content metadata (generated content list) corresponding to each stored content and transmits them to a CP device, a CMP, or a DMC.

As the number of UPnP devices or DLNA devices used in homes or markets is increased, it is generalized that a plurality of digital media servers are included on a home network. As the number of digital media servers on a home network is increased, it becomes more difficult to find, manage, and organize media contents in a plurality of digital media servers. If a user cannot know which server contains contents that the user wants to find using the UPnP technology or DLNA technology, all digital medial servers on a home network need to be searched.

### SUMMARY

Embodiments provide a control device for setting an aggregation server that collects information stored in another server among a plurality of servers belonging to the same network.

Embodiments also provide a control device for setting a negotiation server that activates an aggregation function of another server.

In one embodiment, a method of transmitting content information, the method comprising: transmitting an aggregation mode obtaining action to a media server; receiving information on the aggregation mode corresponding to the service description request signal transmitted from the media server; determining whether the media server perform an aggregation function using the information on an aggregation mode.

In another embodiment, a control device comprises: a network interface transmitting an aggregation mode obtaining action to a media server, and receiving information on the aggregation mode corresponding to the aggregation mode obtaining action transmitted from the media server; and a control unit determining whether the media server perform an aggregation function using information on an aggregation mode.

The details of one or more embodiments are set forth in the accompanying drawings and the description below. Other features will be apparent from the description and drawings, and from the claims.

### BRIEF DESCRIPTION OF THE DRAWINGS

FIG. 1 is a flowchart illustrating a content information aggregation operation of a media server according to an embodiment of the present invention.

FIG. 2 is a flowchart illustrating a method of distinguishing a media server supporting a content information aggregation function according to an embodiment of the present invention.

FIG. 3 is a flowchart illustrating a method of setting an AMS executing a content information aggregation protocol according to another embodiment of the present invention.

FIG. 4 is a flowchart illustrating a method of setting an AMS executing a content information aggregation protocol according to another embodiment of the present invention.

FIG. 5 is a block diagram of devices constituting a 2 box model according to an embodiment of the present invention.

FIG. 6 is a block diagram of devices constituting a 3 box model according to an embodiment of the present invention.

FIG. 7 is a flowchart illustrating a method of setting an AMS by a negotiation media server according to an embodiment of the present invention.

FIG. 8 is a flowchart illustrating a method of setting a negotiation media server according to an embodiment of the present invention.

FIG. 9 is a flowchart illustrating a standard of setting an AMS by a negotiation media server according to an embodiment of the present invention.

FIG. 10 is a view illustrating an AMS setting standard according to an embodiment of the present invention.

FIG. 11 is a view illustrating an AMS setting standard according to another embodiment of the present invention.

FIG. 12 is a flowchart illustrating a state change of an aggregation mode of a media server supporting a content information aggregation function according to an embodiment of the present invention.

### DETAILED DESCRIPTION OF THE EMBODIMENTS

Hereinafter, a mobile terminal relating to the present invention will be described in more detail with reference to the drawings. The suffix “module” and “unit” for components, which are used in the description below, are assigned and mixed in consideration of only the easiness in writing the specification. That is, the suffix itself does not have different meanings or roles

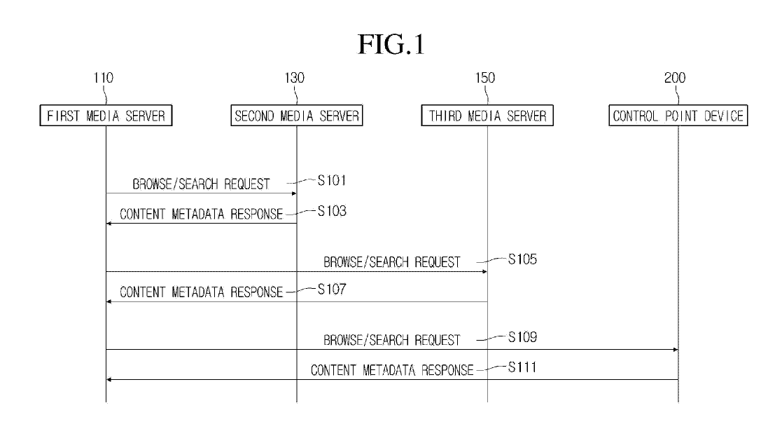

Hereinafter, referring to FIG. 1, a content information aggregation protocol according to an embodiment of the present invention will be described.

FIG. 1 is a flowchart illustrating a content information aggregation operation of a media server according to an embodiment of the present invention. Hereinafter, the media server is used as a digital media server with the same meaning. Additionally, content is used as media content with the same meaning. Content information may include content metadata or content objects in a sense. The content objects may mean a set of content metadata. The content objects may include an item object of a single file format and a container object in a folder format including a plurality of files.

Referring to FIG. 1, a first media server 110 may receive content metadata transmitted from each of a plurality of media servers 130 and 150. A media server provides a content directory service (CDS) in order to allow a user to browse the content stored in the media server and obtain the detail information on each content.

The first media server 110 may receive each content metadata from the second media server 130 and the third media server 150 by using the Browse/Search action of the CDS. For example, when the first media server 110 requests the Browse/Search action to the second media server 130, the second media server 130 may transmit each content metadata of the content stored in the second media server 130 to the first media server 110 by using the CDS in response to the request. Additionally, the first media server 110 requests the Browse/Search action to the third media server 150 in operation S105, and receives each content metadata of the content stored in the third media server 150 from the third media server 150 in response to the request in operation S107. Then, the first media server 110 may collect all content information within a home network for providing a unified user experience. The aggregation function of the first media server 110 may be activated or deactivated (turn on/off). The first media server 110 may provide useful information on aggregation through state variables, content metadata, and additional control mechanism. The additional useful control mechanism provides several actions, thereby providing more improved user experience.

At this point, the content metadata set, that is, a content object, which becomes a collection target of an aggregated media server (AMS) such as the first media server 110 after being included in the second media server 130 and the third media server 150, that is, a content object, may be defined as an aggregated object. The AMS may collect the aggregated object and then, may recreate an aggregate object corresponding thereto. That is, the aggregate object may be defined as an object that is recreated by the AMS on the basis of the content metadata collected from an aggregated media server (ADMS) such as the second media server 130 and the third media server 150 and the same aggregated CDS.

According to an embodiment of the present invention, the first media server 110, as a virtual server, i.e. a kind of a media server, may collect all content metadata physically or logically by using the CDS. At this point, the virtual server may collect content metadata stored in any device. Accordingly, the virtual server may collect content metadata from a plurality of native servers. The native server may mean a server of the original meaning, which stores or provides content and content related information, like the above-mentioned second media server 130 and third media server 150. On the other hand, the virtual server may perform the same function as a control point device that requests and receives content or content related information.

Moreover, in the case of a virtual server collecting content from a plurality of native servers, it needs to have a unique name on a network in order to represent a function that an aggregating virtual server performs content transformation. Additionally, when the aggregating virtual server virtualizes an issue of ssdp:byebye or CACHE-CONTROL intervals of all native servers expire without receiving an advertisement set, An ssdp:byebye message needs to be issued within a predetermined time, for example, 5 sec. A Simple Service Discovery Protocol (SSDP) means a protocol for searching for an available service with a device connected to a network.

A virtual server that does not collect content from a plurality of native servers needs to provide all actions that a basic native server provides. Additionally, a virtual server that does not perform an aggregation function needs to allow all events of a native server to be possible. On the other hand, a virtual server that collects content from a plurality of native servers may restrict an action or event that the virtual server itself provides.

While a virtual server collects content metadata from a large number of native servers, if one of the native servers leaves a network, a query issued after the native server leaves the network, for example, after 1 sec, should not show content metadata of a content stored in the native server that leaves the network in a layer.

According to an embodiment of the present invention, if an aggregation virtual server collects a content from a plurality of native servers, it should be capable of collecting content metadata from all native servers on a current network, and should specify a “*” flag in a <dlna:X_DLNAVIRT> XML element of a device description of the aggregation virtual server.

Then, if there are a plurality of media servers, a control point device 200, which receives a user input including a search request on content metadata of a media content, requests a browse/search action to the first media server 110 performing a function of a virtual server in operation S109, and receives the content metadata stored in the first media server 110 in operation S111. The content metadata stored in the first media server 110 may include all content metadata collected from the plurality of media servers 130 and 150 in a home network. Accordingly, the control point device 200 may receive all content metadata included in all the plurality of media servers by just requesting a browse/search action once to one media server. This is efficient when a user wants to find a specific content, whose location is not known in a media server on a home network including a plurality of media servers.

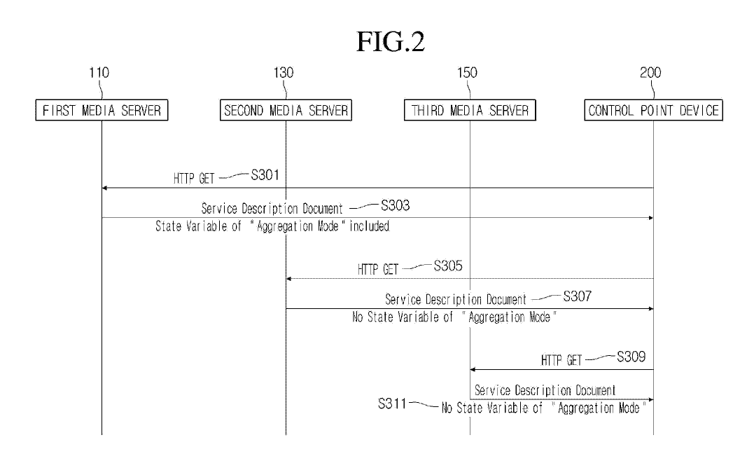

Hereinafter, referring to FIGS. 2 to 4, a content information aggregation protocol according to an embodiment of the present invention will be described.

FIG. 2 is a flowchart illustrating a method of distinguishing a media server supporting a content information aggregation function according to an embodiment of the present invention.

Referring to FIG. 2, a control point device 200 may receive a Service Description Document in a document format from each of a plurality of media servers. The control point device 200 may recognize that a corresponding media server is a media server supporting a content information aggregation function by using the received service description.

The media server may provide an aggregation CDS. The aggregation CDS may provide a single point device to access all contents in a home network. A physical CDS structure or a virtual structure of an aggregation CDS may provide at least one control point module. The control point module may be defined as a module that sets metadata properties relating to an aggregation characteristic and operates actions relating to an aggregation characteristic. For example, the control point module may be a module that performs the same function as the control point device for requesting and receiving a content stored in other media servers and content related information in the above-described virtual server. That is, the media server providing an aggregation CDS may include a control point module that collects contents of other media servers and content related information.

The service description may include information on a service that a media server provides. The control point device 200 may transmit an HTTP GET request to a media server, and may receive the service description of a corresponding media server created in an XML format in response to the request. Thus, a procedure described with reference to FIG. 2 may be performed during a process that the control point device 200 searches for an UPnP device or a DLNA device included in a home network.

The control point device 200 may determine whether a corresponding media server supports a content information aggregation function according to whether an AggregationMode State Variable is included in the received service description. The media server may be divided into a media server supporting a content information aggregation function and a media server not supporting a content information aggregation function, according to whether to support a content information aggregation function. Additionally, the media server supporting a content information aggregation function may be divided into an Aggregation Capable Media Server (ACMS) and an Aggregation Media Server (AMS). The ACMS may mean a server that is capable of performing a content information aggregation function but currently does not perform it, and the AMS may mean a media server that is currently performing a content information aggregation function. Hereinafter, a Legacy Media Server (LMS) is used as a media server that does not support a content information aggregation function with the same meaning. Additionally, in correspondence to an AMS (i.e. a media server currently performing a content information aggregation function), a media server, which is a target of content information aggregation of a current AMS, may be defined as an ADMS.

Even if there is a media server supporting a content information aggregation function in a network, the control point device 200 may not distinguish a media server supporting a content information aggregation function from a media server not supporting a content information aggregation function. Accordingly, the control point device 200 may request a service description to each of a plurality of media servers, and by receiving the service description including an Aggregation mode state variable, may distinguish a media server supporting a content information aggregation function.

A media server supporting a content information aggregation function may show that the media server itself is a media server supporting a content information aggregation function by transmitting a newly defined state variable such as an aggregation mode state variable to the control point device 200. As shown in FIG. 2, when the control point device 200 requests an HTTP GET to the first media server 110 in operation S301, the first media server 110 transmits a service description document including an aggregation mode state variable to the control point device 200 in response to the request in operation S303. The control point device 200 may recognize that the first media server 110 is a media server supporting a content information aggregation function through the aggregation mode state variable included in the service description document.

On the other hand, a media server not supporting content information aggregation function may transmit a service description not including an aggregation mode state variable to the control point device 200. As shown in FIG. 2, when the control point device 200 requests an HTTP GET to the second media server 130 or the third media server 150 in operations S305 and S309, the second media server 130 or the third media server 150 transmits a service description document not including an aggregation mode state variable to the control point device 200 in response to the request in operations S307 and S311. The control point device 200 may confirm that the aggregation mode state variable is not included in the service description document, and thus, may recognize that the second media server 130 or the third media server 150 is a media server not supporting a content information aggregation function.

The properties of an aggregation mode state variable may include a state variable name, an event, a data type, and a default value, and are not limited thereto. The state variable name is an aggregation mode. The event is possible, and an AMS may notify a control point device or other ACMSs that the AMS itself is a media server performing a current content information aggregation function. The event may be impossible, and in this case, the control point device 200 may recognize, by applying an action for obtaining an aggregation mode to an AMS, whether a corresponding AMS performs an aggregation function. The data type may be a Boolean type. When the data value is ‘0’, this is the case that the aggregation function of a corresponding media server is turned off, and represents that the corresponding media server is an ACMS not an AMS. When the data value is ‘1’, this is the case that the aggregation function of a corresponding media server at that instant is turned on, and represents that the corresponding media server is an AMS. The default value may be determined according to a policy. For example, when a media server is basically set up as an ACMS with the default value of ‘0’, unnecessary network traffic caused due to at least one AMS may be prevented.

Hereinafter, when a plurality of AMSs on a network performs a content information aggregation function, a method of setting only one media server among the AMSs as an AMS will be described.

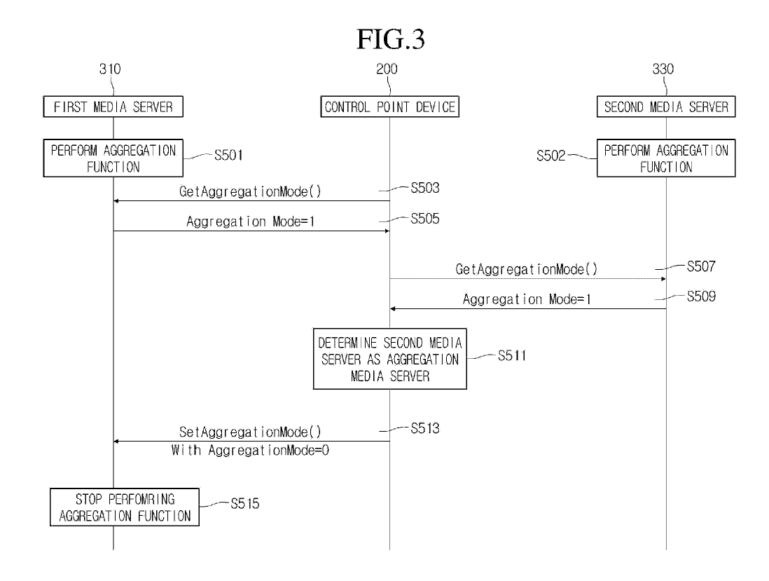

FIG. 3 is a flowchart illustrating a method of setting an AMS executing a content information aggregation protocol according to another embodiment of the present invention.

Referring to FIG. 3, each of a first media server 310 and a second media server 330 on one network performs an aggregation function in operations S501 and S502. Each of the first media server 310 and the second media server 330 is a media server supporting a content information aggregation function. For example, when all the data values of aggregation mode state variables correspond to ‘1’, it indicates that current content information aggregation functions are turned on. That is, all the first media server 310 and second media server 300 correspond to an AMS.

A control point device 200 transmits a GetAggregationMode to the first media server 310 in operation S503. The GetAggregationMode may be a command on requesting an aggregation mode state variable to distinguish an AMS among media servers supporting a plurality of content information aggregation functions.

The control point device 200 may confirm whether to support the content information aggregation function of a media server according to a user input received through an internally or externally connected user interface. For example, when receiving a user input for selecting the first media server 310 or the second media server 330 through the user interface, the control point device 200 may transmit a GetAggregationMode to the selected media server, and, by receiving a response signal corresponding to the GetAggregationMode, may confirm whether to support the content information aggregation function of the selected media server in response to the user input.

The properties of the GetAggregationMode may include an action name, arguments, and related state variables, and are not limited thereto. The action name may be a GetAggregationMode. The argument, as a variable corresponding to a command, may be an AggregationMode corresponding to the GetAggregationMode; the direction of the AggregationMode may be defined as OUT; and a target receiving the GetAggregationMode, for example, the first media server 310, may be a subject transmitting the AggregationMode. The related state variable may be an AggregationMode. When the recovered value of the related state variable is ‘0’, it means that a corresponding media server is an ACMS not an AMS, and when the recovered value of the related state variable is ‘1’, it means that a corresponding media server is an AMS.

The control point device 200 receives information including an AggregationMode transmitted from the first media server 310, in response to the GetAggregationMode in operation S505. When the first media server 310 transmits the AggregationMode having the data value of ‘1’, the control point device 200 recognizes that the first media server 310 is an AMS. Moreover, the control point device 200 may recognize that a corresponding media server is an AMS through an event message transmitted from the media server without transmitting the GetAggregationMode to the media server, and is not limited thereto. For example, the control point device 200 may recognize that the first media server 310 is an AMS by receiving the event message including the AggregationMode having the data value of ‘1’.

Additionally, the first media server 310 may transmit a device description to the control point device 200 in response to a device description request transmitted from the control point device 200. At this point, the device description may include a FriendlyName changed together with the AggregationMode. For example, when being connected to a plurality of servers, the control point device 200 may display a media server FriendlyName list including the FriendlyNames of the plurality of servers on a display unit in order to provide it to a user. Then, when receiving the changed FriendlyName transmitted from the first media server 310, the control point device 200 may display the changed FriendlyName of the first media server 310 on a display unit. A user may identify a media server executing an aggregation mode through the media server FriendlyName list displayed on the display unit of the control point device 200. Since the FriendlyName represents an aggregation mode state of a corresponding media server, for example, “all your content aggregated”, a user may distinguish the manufacturer name or model name of a corresponding media server from the id that is difficult to identify the state of a corresponding media server. Thus, when an AMS starts to perform an aggregation function, it may notify the control point device 200 whether to support an aggregation function by changing the FriendlyName representing an operation for collecting content metadata in a corresponding network.

As described above, the control point device 200 transmits a GetAggregationMode to the second media server 330 in operation S507. For this, when the second media server 330 transmits the AggregationMode having the data value of ‘1’ in operation S509, the control point device 200 recognizes that the second media server 330 is an AMS.

Then, the control point device 200 sets the second media server 330 as an AMS in operation S511. That is, the control point device 200 sets only the second media server 330 as an AMS, and sets the first media server 310 as an ACMS, not any more an AMS. In this case, the first media server 310, as an aggregation function target, may be an ADMS, but is not limited thereto. The control point device 200 may recognize that a plurality of media servers execute current content information aggregations through the AggregationMode transmitted from the first media server 310 and the second media server 330. However, if two AMSs are not necessary in one network, only one of them performing an aggregation function is enough. The control point device 200 may confirm whether a media server supports and performs an aggregation function, and may control it. According to a control of the control point device 200, a target media server may or may not perform an aggregation function.

Additionally, the control point device 200 may receive a user input for setting or changing an aggregation mode state of a media server through a user interface. According to an embodiment of the present invention, the control point device 200 may receive a user input for selecting one media server among a plurality of media servers performing a plurality of aggregation functions as a server for performing an aggregation function, through a user interface. For example, the control point device 200 may receive a user input for setting the aggregation mode state of the second media server to “on” or a user input for setting the aggregation mode state of the first media server 310 to “off”, through the user interface.

Then, the control point device 200 transmits a SetAggregationMode including the AggregationMode having the data value of ‘0’ to the first media server 310 in operation S513. The control point device 200 may stop the aggregation function of the first media server 310 in order to allow only the second media server 330 to perform a content information aggregation function. The control point device 200 may control the aggregation function of the first media server 310 by using a SetAggregationMode. The SetAggregationMode may be a control command for controlling the aggregation function of a media server supporting a content information aggregation function to be activated or deactivated.

The properties of the SetAggregationMode may include an action name, arguments, and related state variables, and are not limited thereto. The action name may be a SetAggregationMode. The argument, as a variable corresponding to a command, may be an AggregationMode corresponding to the SetAggregationMode; the direction of the AggregationMode may be defined as IN; and a target receiving the SetAggregationMode, for example, the first media server 310, may receive the AggregationMode also. At this point, error codes may include 741, i.e. a useless parameter. The error codes may mean that the value of an aggregation mode argument is identical to the current value of an aggregation state variable. The related state variable may be an AggregationMode. When the recovered value of the related state variable is ‘0’, it means that the aggregation mode of a corresponding media server is deactivated, and when the recovered value of the related state variable is ‘1’, it means that the aggregation mode of a corresponding media server is activated.

The first media server 310, which receives the SetAggregationMode including the AggregationMode having the data value of ‘0’, stops the aggregation function in operation S515. Therefore, according to a control of the control point device 200, only the second media server 330 as an AMS may perform a content information aggregation function on a network.

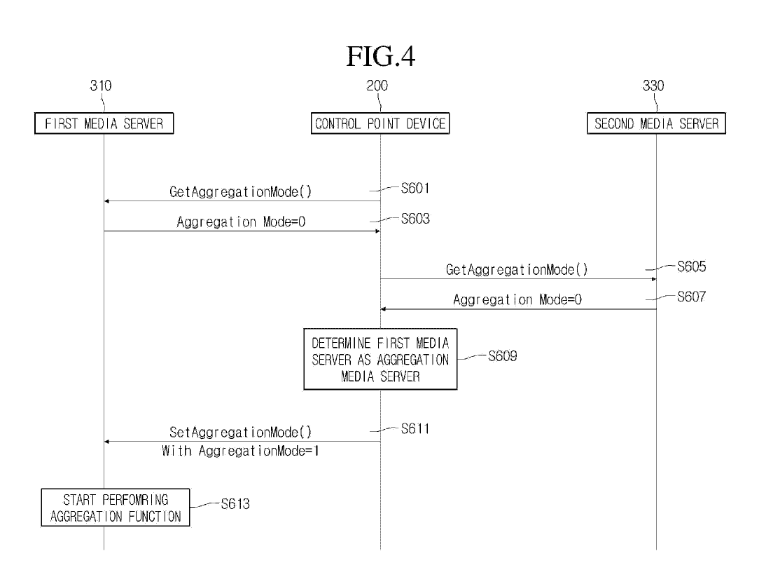

FIG. 4 is a flowchart illustrating a method of setting an AMS executing a content information aggregation protocol according to another embodiment of the present invention.

Hereinafter, the same part described with reference to FIG. 3 will be omitted.

Referring to FIG. 4, each of a first media server 310 and a second media server 330 does not perform an aggregation function on one network. In relation to the first media server 310 and the second media server 330, since all the data values of the AggregationMode correspond to ‘0’, a current content information aggregation function may be turned off.

When the control point device 200 transmits a GetAggregationMode to the first media server 310 in operation S601, it receives information including an AggregationMode transmitted from the first media server 310, in response to the GetAggregationMode in operation S603. When the first media server 310 transmits the AggregationMode having the data value of ‘0’, the control point device 200 recognizes that the first media server 310 does not perform a function of an AMS. Moreover, the control point device 200 may recognize whether a corresponding media server performs an aggregation function through an event message transmitted from the media server without transmitting the GetAggregationMode to the media server, and is not limited thereto. For example, the control point device 200 may recognize that the first media server 310 does not perform a function of an AMS by receiving the event message including the AggregationMode having the data value of ‘0’.

The control point device 200 transmits a GetAggregationMode to the second media server 330 separately in operation S605. For this, when the second media server 330 transmits information including the AggregationMode having the data value of ‘0’ in operation S607, the control point device 200 recognizes that the second media server 330 does not perform a function of an AMS. Then, the control point device 200 sets the first media server 310 as an AMS in operation S609.

The control point device 200 transmits a SetAggregationMode including the AggregationMode having the data value of ‘1’ to the first media server 310 set as the AMS in operation S611.

The first media server 310, which receives the SetAggregationMode including the AggregationMode having the data value of ‘1’, starts the aggregation function in operation S613. Therefore, according to a control of the control point device 200, only the first media server 310 as an AMS may perform a content information aggregation function on a network.

Hereinafter, a structure of a device constituting a 2 box model and a 3 box model of a DLNA will be described according to an embodiment of the present invention.

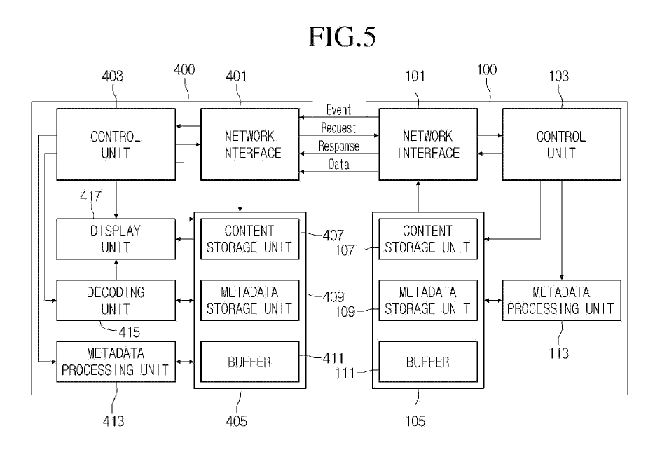

FIG. 5 is a block diagram of devices constituting a 2 box model according to an embodiment of the present invention.

Referring to FIG. 5, the 2 box model of the DLNA includes a media server 100 and a media player 400. The media server may transmit an event message to a media player 400. Or, the media server 100 may transmit a response in response to the request transmitted from the media player 400. The media server 100 may transmit the data stored in the memory 105 thereof to the media player 400. The media player 400 may process and play the data transmitted from the media server 100.

The media server 100 may include a network interface 101, a control unit 103, a memory 105, and a metadata processing unit 113.

The network interface 101 of the media server 100 may receive a message including a command, request, and action, which is transmitted from the media player 400. Additionally, the network interface 101 may transmit an event message and data to the media player 400. The network interface 101 may be a physical element of the media server 100.

The control unit 103 controls an operation of each element included in the media server 100 on the basis of user input or software. The control unit 103 may be a logical element of the media server 100. For example, the control unit 103 may extracts the content metadata stored in the memory 105, and then, may transmit them to the external through the network interface 101, in response to the request received through the network interface 101.

The memory 105 stores various kinds of information. The memory 105 may be a physical element of the media server 100. The memory 105 includes a content storage unit 107, a metadata storage unit 109, and a buffer 111. The content storage unit 107 may store media content data. The metadata storage unit 109 may store metadata, i.e. information on content. The metadata storage unit 109 may classify metadata, and then, may store them. The buffer 111 may temporarily store various kinds of data. Additionally, the memory 105 may store state information on the media server 100. The state information may include information on the hardware state or a software state of the media server 100. For example, the state information may include information on the storage size, memory, CPU performance, XML parsing capability, content change capability, connection and transfer protocol, number of stored contents, device type, aggregation mode state, and negotiation mode state of the media server 100.

The metadata processing unit 113 extracts and separates the metadata of the media content stored in the content storage unit 107. The metadata that the metadata processing unit 113 extracts and separates may be stored in the metadata storage unit 109.

Since the media server 100 stores metadata (i.e. content related information) in addition to content, it may provide information on the stored content, and also, may provide content streaming service and content upload/download service.

The media player 400 may include a network interface 401, a control unit 403, a memory 405, a metadata processing unit 413, a decoding unit 415, and a display unit 417, and may perform all functions of the above-mentioned media controller and media renderer. Hereinafter, the same part described above will be omitted.

The network interface 401 may transmit a message including a command, request, and action to the media server 100. Additionally, the network interface 401 may receive an event message and data from the media server 100.

The control unit 403 controls an operation of each element included in the media server 100 on the basis of user input or software. For example, the control unit 403 may store in the memory 405 the content received through the network interface 401, and then, may process the stored content in the decoding unit 415 in order to display the processed content on the display unit 147.

The memory 405 includes a content storage unit 407, a metadata storage unit 409, and a buffer 411. The content storage unit 407 may store the media content transmitted from the media server 100. The metadata storage unit 409 may store the metadata transmitted from the media server 100.

The metadata processing unit 413 may distinguish the data type of the metadata transmitted from the media server 100, and then, may classify them into a predetermined category in order to allow the control unit 403 to visualize or control them.

The decoding unit 415 may decode the encoded media content in order to display them on the display unit 417.

The display unit 417 visualizes various kinds of data such as a user interface or media and displays them. A user may provide a user input through a user interface displayed on the display unit 417, or may use media in a way of displaying the media on the display unit 417.

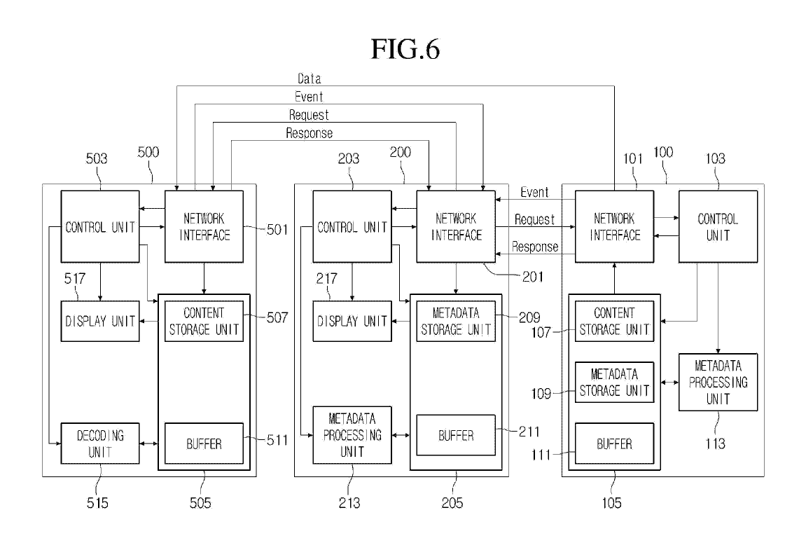

FIG. 6 is a block diagram of devices constituting a 3 box model according to an embodiment of the present invention. Hereinafter, the same configuration described with the 2 box model will be omitted.

The 3 box model of a DLNA includes a media server 100 and a media controller 200, and a media renderer 500. The media server 100 may transmit to the media controller 200 an event message or a response in response to the request transmitted from the media controller 200. The media controller 200 may transmit to the media renderer 500 an event message or a response in response to the request transmitted from the media renderer 500. The media server 100 may transmit data to the media renderer 500 in response to the request transmitted from the media controller 200. The media renderer 500 may display the data transmitted from the media server 100 on the display unit 517. The media controller 200 in the 3 box model may store and process the metadata on a content transmitted from the media server 100, and the media renderer 500 may store, process, and display the content transmitted from the media server 100.

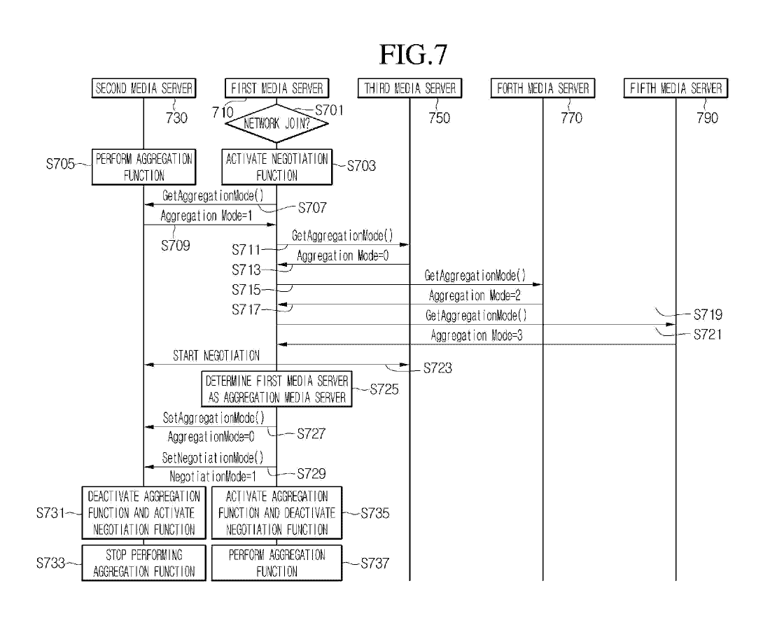

Hereinafter, referring to FIG. 7, a method of setting an AMS by a negotiation media server according to an embodiment of the present invention will be described.

FIG. 7 is a flowchart illustrating a method of setting an AMS by a negotiation media server according to an embodiment of the present invention.

Referring to FIG. 7, the first media server 710 may set at least one among a plurality of aggregation available media servers in the same network, for example, the second to fifth media servers 730, 750, 770, and 790.

When a plurality of aggregation available media servers are connected to one network, even if a request signal is not transmitted from a control point device controlled by a user input, it is necessary for an aggregation available media server to automatically control whether to activate an aggregation function of an aggregation available media server.

However, since the control of an aggregation available media server may be done different from a user intention due to another aggregation available media server, it is necessary to instruct and set whether the aggregation function of an aggregation available media server is controlled by another aggregation available media server.

Negotiation procedures may mean automatic procedures that automatically set at least one of a plurality of aggregation available media servers as an AMS for performing an aggregation function. For example, an aggregation available media server may start such negotiation procedures.

A negotiation media server, i.e. a negotiator, may mean an aggregation available media server that starts a negotiation procedure. For example, an aggregation available media server that newly joins a network may be a negotiation media server automatically. Additionally, when a situation of a negotiation media server is changed, for example, when it becomes an AMS or is disconnected from a corresponding network, the negotiation media server may assign a negotiation media server role to another aggregation available media server in advance. When a network is disconnected, a negotiation media server may notify this to an AMS.

If there is no negotiation media server in one network, an AMS may be responsible for assigning a negotiation media server role to one aggregation available media server in a corresponding network.

Referring to FIG. 7, when the first media server 710 newly joins a network including the second to fifth media servers 730, 750, 770, and 790 in operation S701, it may be a negotiation media server. The first media server 710, i.e. a negotiation media server, may activate a negotiation function in operation S703, and then, may collect information on an aggregation mode for each of a plurality of media servers, before starting a negotiation procedure for setting the one to fifth media servers 710, 730, 750, 770, and 790, i.e. aggregation available media server, as one AMS.

The first media server 710 transmits a GetAggregationMode to the second to fifth media servers 730, 750, 770, and 790 in operations S707, S711, S715, and S719. The second to fifth media servers 730, 750, 770, and 790 receiving the GetAggregationMode may transmit a state variable having a specific value to the first media server 710. The response transmitted in response to the GetAggregationMode may include at least one of a ControllableAggregationMode state variable and an AggregationMode state variable.

The properties of a controllable AggregationMode may include a state variable name, an event, a data type, an allowed value, and a default value, and are not limited thereto. The state variable name is a ControllableAggregationMode. An event may or may not be possible. The data type may be a Boolean type or a string type. When the data type is a Boolean type, an allowed value may be ‘0’ or ‘1’. When the allowed value is ‘0’, it means that a corresponding aggregation available media server cannot be controlled by another aggregation available media server, and when the allowed value is ‘1’, it means that a corresponding aggregation available media server can be controlled by another aggregation available media server. If the data type is a string type, an allowed value may be Not_Controllable_by_ACMS or Controllable_by_ACMS. The default value may be determined according to a policy, and for example, it is recommended that a media server be set to be controlled by another aggregation available media server with the default value of ‘1’. However, the default value is not limited thereto.

The properties of an AggregationMode may include a state variable name, an event, a data type, an allowed value, and a default value, and are not limited thereto. An AggregationMode described below may have the same concept as the above, or a more extended concept in terms of the data type. Hereinafter, description for the same part of the above AggregationMode will be omitted, and only the differences will be described.

The data type of the AggregationMode may allow any data type indicating four different states. For example, the data type may be ‘ui1’ or ‘ui4’. Additionally, a string type may be applicable. If the data type is an integer type such as ‘ui1’ or ‘ui4’ with an allowed value of ‘0’, it means that a content information aggregation function can be performed but a current content information aggregation function is not performed, and a corresponding aggregation available media server can be controlled by another aggregation available media server. If the allowed value is ‘1’, it means that a current content information aggregation function is performed, and a corresponding aggregation available media server can be controlled by another aggregation available media server. If the allowed value is ‘2’, it means that a current content information aggregation function is performed, but a current content information aggregation function is not performed and a corresponding aggregation available media server cannot be controlled by another aggregation available media server. If the allowed value is ‘3’, it means that a current content information aggregation function is performed, and a corresponding aggregation available media server cannot be controlled by another aggregation available media server. If the data type is a string type, an allowed value may be Controllable_ACMS_by_ACMS, Controllable_AMS_by_ACMS, Not_Controllable_ACMS_by_ACMS, or Not_Controllable_AMS_by_ACMS. The default value may be determined according to a policy.

The first media server 710 transmits a GetAggregationMode to the second media server 730 in operation S707. Since the second media server 730 currently performs a content information aggregation function on a corresponding network in operation S705, it transmits the AggregationMode having the allowed value of ‘1’ to the first media server 710 in response to the GetAggregationMode. The first media server 710 recognizes that the second media server 730 performs a current content information aggregation function and can be controlled by another aggregation available media server, on the basis of the allowed value of the AggregationMode transmitted from the second media server 730.

The first media server 710 transmits a GetAggregationMode to the third media server 750 in operation S711. The third media server 750 transmits the AggregationMode having the allowed value of ‘0’ to the first media server 710 in response to the GetAggregationMode in operation S713. The first media server 710 recognizes that the third media server 750 can perform a content information aggregation function but does not currently perform the content information aggregation function and can be controlled by another aggregation available media server, on the basis of the allowed value of the AggregationMode transmitted from the third media server 750.

The first media server 710 transmits a GetAggregationMode to the fourth media server 770 in operation S715. The fourth media server 770 transmits the AggregationMode having the allowed value of ‘2’ to the first media server 710 in response to the GetAggregationMode in operation S717. The first media server 710 recognizes that the fourth media server 770 can perform a content information aggregation function but does not currently perform the content information aggregation function and cannot be controlled by another aggregation available media server, on the basis of the allowed value of the AggregationMode transmitted from the fourth media server 770.

The first media server 710 transmits a GetAggregationMode to the fifth media server 790 in operation S719. The fifth media server 790 transmits the AggregationMode having the allowed value of ‘3’ to the first media server 710 in response to the GetAggregationMode in operation S721. The first media server 710 recognizes that the fifth media server 790 performs a current content information aggregation function and cannot be controlled by another aggregation available media server, on the basis of the allowed value of the AggregationMode transmitted from the fifth media server 790.

Then, the first media server 710 starts a negotiation procedure with the second media server 730 that can be controlled by another media server among the second media server 730 and the fifth media server 790 which are AMSs currently performing an aggregation function, in operation S723. The first media server 710 may start a negotiation to set at least one among a plurality of media servers as an AMS, on the basis of information on an aggregation mode collected from each of a plurality of media servers. The negotiation procedure may be a procedure starting between media servers that can be controlled by another media server and a negotiation media server.

Then, on the basis of the negotiation result, when the first media server 710 among the first media server 710 and the second media server 730 is set as an AMS in operation S725, the first media server 710 deactivates the aggregation function of the second media server 730 while activating the aggregation function of the first media server 710. The first media server 710 transmits a SetAggregationMode including AggregationMode=0 having the data type of ‘0’ to the second media server 730 in order to deactivate the aggregation function of the second media server 730 in operation S727. Additionally, the first media server 710 deactivates a negotiation function while activating the aggregation function of the first media server 710 in operation S735. The aggregation function activation and negotiation function deactivation of the first media server 710 may be simultaneously completed, but are not limited thereto. Operations S727 and S735 may be performed simultaneously, but are not limited thereto.

Additionally, the first media server 710 transmits a SetNegotiationMode including a NegotiationMode having the allowed value of ‘1’ to the second media server 730 in operation S729. The first media server 710 itself becomes an AMS, and hands over a negotiation media server role to the second media server 730.

The properties of a negotiation mode state variable may include a state variable name, an event, a data type, an allowed value, and a default value, and are not limited thereto. The state variable name is a NegotiationMode. An event is possible, and an AMS may recognize whether a negotiation media server exists in a corresponding network through an event including a negotiation mode state variable. The data type may be a Boolean type or a string type. When the data type is a Boolean type, an allowed value may be ‘0’ or ‘1’. When the allowed value is ‘0’, it means that a corresponding media server is not a negotiation media server, and when the allowed value is ‘1’, it means that a corresponding media server is a negotiation media server. When the data type is a string type, the allowed value may be a ‘negotiator’ or a ‘Not a Negotiator’. With the default value is ‘1’, when an aggregation available media server joins one network, it may start an aggregation procedure, but is not limited thereto.

The properties of the SetNegotiationMode may include an action name and arguments, and are not limited thereto. The action name may be a SetAggregationMode. The argument, as a variable corresponding to a command, may include an argument name, an argument direction, and a related state variable, and is not limited thereto. The name of an argument corresponding to a SetAggregationMode may be a NegotiationMode; the transmission direction may be defined as IN; and the first media server 710 transmitting a SetNegotiationMode is a subject transmitting a negotiation mode state variable. The related state variable may be a NegotiationMode.

Then, the second media server 730 receiving the SetAggregationMode including the AggregationMode having the value of ‘0’ and the SetAggregationMode including a negotiation mode state variable having the value of ‘1’ activates a negotiation function while deactivating an aggregation function in operation S731. The deactivation of an aggregation function and the activation of a negotiation function may be performed simultaneously, but are not limited thereto. Accordingly, the second media server 730 stops performing the aggregation function in operation S733. The second media server 730 may restart a negotiation procedure as a negotiation media server in order to set a new AMS, when there is no AMS, for example, when the network connection of the first media server 710 performing a current aggregation function is interrupted.

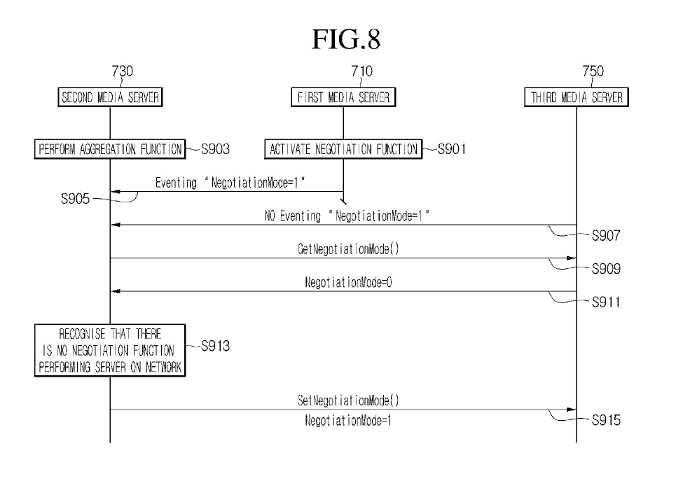

Next, referring to FIG. 8, when a network access of a negotiation media server is released without an additional notification, a method of setting a new negotiation media server will be described.

FIG. 8 is a flowchart illustrating a method of setting a negotiation media server according to an embodiment of the present invention.

Referring to FIG. 8, the first media server 710 activates a negotiation function in operation S901. The first media server 710 may perform the role of a current negotiation media server in one network.

The first media server 710, as a negotiation media server, transmits an event message including a negotiation mode state variable having the allowed value of ‘1’ to the second media server 730 in operation S905, which is an AMS performing a current aggregation function in operation S903. The second media server 730, which receives an event message including the negotiation mode state variable having the allowed value of ‘1’, recognizes that the first media server 710 is a negotiation media server.

Then, the network access release occurs without a notification or handing over a role of a negotiation media server from the first media server 710 to another media server.

The second media server 730, i.e. an AMS, may confirm whether a negotiation media server exists in a network. Unlike the above-mentioned event message of the first media server, when the third media server 750, i.e. another media server existing in the same network, does not transmit any event message including a negotiation mode state variable with a specific allowed value in operation S907, the second media server 730 transmits a GetNegotiaionMode to the third media server 750 in operation S909.

The properties of the GetNegotiaionMode may include an action name and arguments, and are not limited thereto. The action name may be a GetNegotiaionMode. The argument, as a variable corresponding to a command, may include an argument name, an argument direction, and a related state variable, and is not limited thereto. The argument name corresponding to the GetNegotiaionMode may be a NegotiationMode. The argument, that is, the transmission direction of a negotiation mode state variable, may be defined as OUT, and a negotiation mode state variable of the third media server 750, for example, a target receiving a GetNegotiaionMode, may be a target argument. The related state variable may be a NegotiationMode.

The third media server 750 transmits the negotiation mode state variable having the allowed value of ‘0’ to the second media server 730 in response to the GetNegotiaionMode in operation S911.

The second media server 730, which does not receive an event message or response message including a negotiation mode state variable having the allowed value of ‘1’ from a media server in a network, recognizes the absence of a negotiation media server, i.e. a server performing a negotiation function on a corresponding network, in operation S913.

Additionally, the second media server 730, which recognizes the absence of a negotiation media server on a network, transmits a SetNegotiationMode including a negotiation mode state variable having the allowed value of ‘1’ to the third media server 750 in operation S915.

The third media server 750, which receives the SetNegotiationMode including the negotiation mode state variable having the allowed value of ‘1’, may become a new negotiation media server.

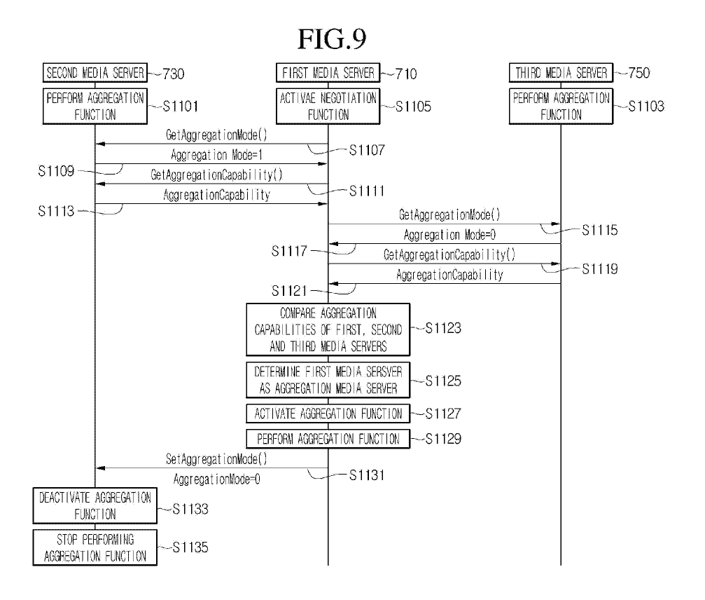

Next, referring to FIGS. 9 to 11, the standard on setting an AMS during a negotiation procedure will be described.

FIG. 9 is a flowchart illustrating the standard on setting an AMS by a negotiation media server according to an embodiment of the present invention.

Referring to FIG. 9, each of a second media server 730 and a third media server 750 in one network is an AMS performing an aggregation function in operations S1101 and S1103.

When newly joining a network including the second media server 730 and the third media server 750, the first media server 710 becomes a negotiation media server to activate the negotiation function of the first media server 710 in operation S1105. In order to evade unnecessary network traffic occurring when a plurality of aggregation available media server or AMSs exist in one network, one or only at least aggregation available media server needs to perform an aggregation function, and since other aggregation available media servers do not need to perform an aggregation function, they are enough to serve as general media servers. Accordingly, for example, in order to specify one aggregation available media server and perform an aggregation function, a negotiation media server may collect information on aggregation capability of a plurality of aggregation available media servers.

The negotiation function activated first media server 710 transmits a GetAggregationMode to the second media server 730 in operation S1107. The second media server 730 transmits an AggregationMode having the data type of ‘1’ in response to the GetAggregationMode transmitted from the first media server 710 in operation S1109.

Then, the first media server 710 transmits a GetAggregationCapability to the second media server 730 in operation S1111. The second media server 730 transmits an AggregationCapability in response to the GetAggregationCapability transmitted from the first media server 710 in operation S1113.

Additionally, the first media server 710 transmits a GetAggregationMode to the third media server 750 in operation S1115. The third media server 750 transmits an AggregationMode having the data type of ‘0’ in response to the GetAggregationMode transmitted from the first media server 710 in operation S1117.

Then, the first media server 710 transmits a GetAggregationCapability to the third media server 750 in operation S1119. The third media server 750 transmits an AggregationCapability in response to the GetAggregationCapability transmitted from the first media server 710 in operation S1121.

Thus, the first media server 710 may recognize that the second media server 730 and the third media server 750 perform an aggregation function in one network through the GetAggregationMode. Accordingly, aggregation available media servers, for example, the first media server 710, the second media server 730, and the third media server 750, need to share information on capabilities and resources of a necessarily and beneficially required media server. It is necessary to define which properties are necessarily and beneficially required capability and resource among device properties of a media server.

The properties of the GetAggregationCapability may include an action name and arguments, and are not limited thereto. The action name may be a GetAggregationCapability. The argument may include an argument name, an argument direction, and a related state variable, and is not limited thereto. The argument name corresponding to a GetAggregationCapability may be an AggregationCapability, and the transmission direction of an AggregationCapability may be defined as OUT. The related state variable may be an AggregationCapability.

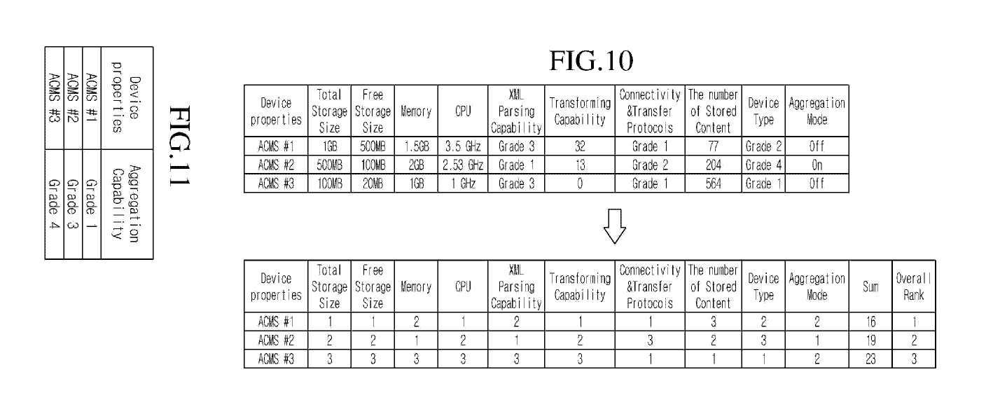

The properties of an AggregationCapability may include a state variable name, an event, a data type, and an allowed value, and are not limited thereto. The state variable name may be an AggregationCapability. An event may or may not be possible. Additionally, the data type may be a string type. The allowed value may be ‘CVS’. The state variable of the ‘CVS’ type may include a plurality of properties. Each data type may be determined by device properties. Hereinafter, referring to FIGS. 10 and 11, information that is to be included in an AggregationCapability will be described.

FIG. 10 is a flowchart illustrating an AMS setting standard according to an embodiment of the present invention.

Referring to FIG. 10, the AggregationCapability according to an embodiment of the present invention includes information on device properties such as a Total Storage Size, a Free Storage Size, a Memory, a CPU, an XML Parsing Capability, a Transforming Capability, a Connectivity & Transfer protocol, The number of stored content, a Device Type, and an Aggregation Mode but is not limited thereto.

The total storage size and the free storage size may be the basis of determining an amount of content metadata that a corresponding media server collects in one network.

The memory may be the basis of determining an amount of content metadata that a corresponding media server handles in one network.

The CPU performance relates to the data management and calculation of a corresponding media server.

Since the metadata is expressed in an XML, the XML parsing capability becomes an important factor, and grade information according to the XML parsing capability is required.

Since an aggregation available media server may change content instead of a media server including actual corresponding content, the Transforming Capability becomes an important property, and the number of file formats that a corresponding media server changes becomes information for describing the transforming capability.

The Connectivity & Transfer protocol may be the basis of determining an amount of data that a corresponding media server transmits to another media server or control point device, and grade information according to the Connectivity & Transfer protocol is required. For example, the higher the grade of the Connectivity & Transfer protocol of a device implemented with Ethernet is better, and when the grade of the Connectivity & Transfer protocol of a device implemented with Bluetooth is low, it is fine.

In relation to the number of stored content, since an aggregation available media server is a server for collecting content metadata from another media server, an aggregation available media server storing a larger number of content metadata needs to collect a less number of content metadata from another media server.

Since it is better for a media server, which accesses a corresponding network longer, to perform an aggregation function, a device type grade is necessary. For example, a device type grade of a mobile device is low, and a device of a high performance such as a PC and a device powered up permanently (or semi-permanently) such as a server attached to a network have a high device type grade.

Since it is convenient for a media server performing a current aggregation function to perform an aggregation function continuously, information on an aggregation mode is necessary.

In operation S1113 of FIG. 9, the second media server 730 may transmit to the first media server 710 the aggregation capability state information including information on the total storage size (500 MB), free storage size (100 MB), memory (2 GB), CPU (2.53 GHz), XML parsing capability (Grade 1), transforming capability (13), Connectivity & Transfer protocol (Grade 2), number of stored content (204), device type (Grade 4), and aggregation mode (ON) of the second media server 730.

In operation S1121 of FIG. 9, the third media server 750 may transmit to the first media server 710 the aggregation capability state information including information on the total storage size (100 MB), free storage size (20 MB), memory (1 GB), CPU (1 GHz), XML parsing capability (Grade 3), transforming capability (0), Connectivity & Transfer protocol (Grade 1), number of stored content (564), device type (Grade 1), and aggregation mode (OFF) of the third media server 750.

FIG. 11 is a view illustrating an AMS setting standard according to another embodiment of the present invention. Referring to FIG. 11, the AggregationCapability according to another embodiment of the present invention includes one value for indicating an aggregation capability grade instead of notifying each of all properties of a corresponding device. Each of a plurality of aggregation available media servers may translate many types of device properties that each has as a grade evaluated with a single integer through a translation rule.

The properties of the AggregationCapability according to another embodiment of the present invention may include a state variable name, an event, a data type, an allowed value, and an allowed value range, and are not limited thereto. The state variable name may be an AggregationCapability. An event may or may not be possible. Additionally, the data type may be a ui4 type. The allowed value may be all integers from ‘0’ to ‘M’, and ‘M’ represents the maximum grade. The allowed value range may be between ‘0’ and ‘M’, and when compared more elaborately, the maximum value may be increased.

In operation S1113 of FIG. 9, the second media server 730 may transmit aggregation capability state information having the allowed value of ‘3’ to the first media server 710.

In operation S1121 of FIG. 9, the third media server 750 may transmit aggregation capability state information having the allowed value of ‘4’ to the first media server 710.

Again, FIG. 9 will be described.

Before, as described with reference to FIGS. 10 and 11, the first media server 710 receives aggregation capability state information transmitted from each of the second media server 730 and the third media server 750, and then compares the aggregation capabilities of the first media server 710, the second media server 730, and the third media server 750 in order to determine a server to become an AMS in operation S1123.

Then, the first media server 710 compares the aggregation capabilities of the first media server 710, the second media server 730, and the third media server 750 and then sets the first media server 710 as an AMS on the bases of a comparison result in operation S1125.

For example, when FIG. 10 is described again, the first media server 710 compares the device properties of the first media server 710, the second media server 730, and the third media server 750 and then ranks them in order to set a media server having the smallest sum of all ranks of each property as an AMS. In FIG. 10, the first media server 710 transmits a GetAggregationCapability to each of the second media server 730 and the third media server 750, and receives an AggregationCapability corresponding thereto in order to collect information on each device property. The first media server 710 compares and ranks each device property and then, adds up the ranks. On the basis of the rank sum result, the rank sum of the first media server 710 is 16; the rank sum of the second media server 730 is 19; and the rank sum of the third media server 750 is 23. Therefore, the first media server 710 having the smallest rank sum may be set as a media server having the most excellent aggregation capability. A method of determining a rank is not limited thereto.

As another example, as described again with reference to FIG. 11, the first media server 710 may receive an AggregationCapability calculated with one grade from each of the second media server 730 and the third media server 750. The first media server 710 compares the received grade of the AggregationCapability with the grade of the AggregationCapability of the first media server 710 and then sets the first media server 710 having the smallest grade number as an AMS.

If the first media server 710 set as an AMS has the AggregationMode value of ‘0’, it changes the AggregationMode value into ‘1’ to activate an aggregation function in operation S1127. The aggregation function activated first media server 710 performs an aggregation function in operation S1129.

Then, the first media server 710 transmits to the second media server 730 the SetAggregationMode including AggregationMode=0 in operation S1131.

The second media server 730 deactivates an aggregation function, for example, by changing the data value of the AggregationMode of the second media server 730 from ‘1’ into ‘0’ in operation S1133. The aggregation function deactivated second media server 730 stops performing an aggregation function in operation S1135.

Then, a process of changing a state of a media server supporting a content information aggregation function into an aggregation available media server and an AMS will be described.

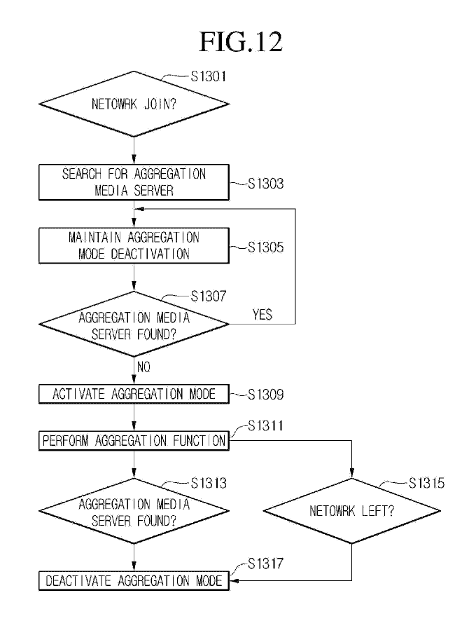

FIG. 12 is a flowchart illustrating a state change of an aggregation mode of a media server supporting a content information aggregation function according to an embodiment of the present invention.

Referring to FIG. 12, when an aggregation available media server supporting a content information aggregation function joins a network in operation S1301, an AMS is searched periodically in order to determine whether there is an AMS among media servers in a corresponding network in operation S1303. At this point, an aggregation available media server may operate as a negotiation media server. In order to search for an AMS, the aggregation available media server may use the above-mentioned GetAggregationMode, or may receive an event message including information on an aggregation mode state transmitted from another aggregation media server or another AMS, and is not limited thereto.

Until it is determined that all media servers in a corresponding network do not perform an aggregation function, that is, until an AMS search is completed, the aggregation available media server maintains an aggregation mode deactivation state in operation S1305.

When an AMS is found in operation S1307, the aggregation available media server maintains the aggregation mode deactivation state, and when an AMS is not found in operation S1307, the aggregation available media server activates the aggregation mode thereof in operation S1309. Additionally, when an AMS is found, the aggregation available media server, as a negotiation media server, compares the aggregation capabilities of a plurality of AMSs, and sets a media server having the most excellent aggregation capability as an AMS. The aggregation available media server may set its AggregationMode value to ‘1’ in order to activate its aggregation mode, but is not limited thereto.

When the aggregation mode is activated, the aggregation available media server performs the aggregation function in operation S1311. For example, the aggregation available media server may become an AMS, and the AMS may collect content metadata stored in a media server in a state that can be controlled by another media server among media servers in a corresponding network.

When another AMS is found in a corresponding network in operation S1313, the AMS deactivates its aggregation mode in operation S1317. Or, the AMS leaves the corresponding network in operation S1315, and after the access is disconnected, deactivates its aggregation mode in operation S1317.

Thus, even when there is no additional control device instruction in a network, since at least one media server collects information stored in a plurality of media servers in a network, a control device may receive information that the plurality of media servers store by requesting information once to one media server.

According to an embodiment of the present invention, an aggregation server that collects information stored in another server among a plurality of servers belonging to the same network may be set.

According to an embodiment of the present invention, a negotiation server that activates an aggregation function of another server may be set.

The various embodiments described herein may be realized in a computer or similar device thereto readable recording medium through software, hardware, or a combination thereof.

According to the hardware realization, the embodiments described herein may be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electrical units for performing other functions. In some cases, the embodiments may be realized by the control unit 180.

According to the software realization, the embodiments relating to procedures or functions may be realized with an additional software module for performing at least one function or operation. A software code may be realized with a software application written in a proper program language. The software code is stored in the memory 160 and is executed by the control unit 180.

According to an embodiment of the present invention, the above method may be realized with codes that a processor can read in a program recorded medium. Examples of the computer readable recording medium include read-only memory (ROM), random-access memory (RAM), CD-ROMs, magnetic tapes, floppy disks, and optical data storage devices, and further includes a carrier wave form (such as data transmission through the Internet).

The above described devices are not limited to the configurations and methods of the above embodiments, and all or some of the above embodiments are selectively combined in order to provide various modified embodiments.

What is claimed is:

1. A method of transmitting content information, the method comprising:
transmitting an aggregation mode obtaining action to a media server;
receiving information on the aggregation mode corresponding to the service description request signal transmitted from the media server;
determining whether the media server perform an aggregation function using the information on an aggregation mode.

2. The method according to claim 1, further comprising receiving a user input to select a media server, wherein the transmitting of the aggregation mode obtaining action to the media server comprises transmitting the aggregation mode obtaining action to a media server selected according to the user input.

3. The method according to claim 1, further comprising, transmitting a content information request signal to the media server according to a determining result; and
receiving content information corresponding to the content information request signal transmitted from the media server,
wherein the content information comprises content information stored in other servers in the same network as the media server.

4. The method according to claim 3, wherein the transmitting of the content information request signal to the media server comprises:
displaying whether the media server perform an aggregation function; and
when a user input is received to select the media server, transmitting a content information request signal to the media server.

5. The method according to claim 3, wherein the information on the aggregation mode comprises information on a current aggregation mode state of the media server;
when the current aggregation mode state is ON, the media server collects content information stored in the other servers; and
when the current aggregation mode state is OFF, the media server does not collect content information stored in the other servers.

6. The method according to claim 5, wherein the transmitting of the content information request signal to the media server comprises, when the current aggregation mode state is ON, transmitting a content information request signal to the media server.

7. The method according to claim 5, wherein the transmitting of the content information request signal to the media server further comprises, when the current aggregation mode state is OFF, transmitting an aggregation mode setting action to the media server to change the current aggregation mode state into ON, wherein the aggregation mode setting action comprises an aggregation mode state variable having the value of ON.

8. The method according to claim 5, further comprising, when the current aggregation mode state is ON, transmitting an aggregation mode setting action to the media server to change the current aggregation mode state into OFF, wherein the aggregation mode setting action comprises an aggregation mode state variable having the value of OFF.

9. A control device comprises:
a network interface transmitting an aggregation mode obtaining action to a media server, and receiving information on the aggregation mode corresponding to the aggregation mode obtaining action transmitted from the media server; and
a control unit determining whether the media server perform an aggregation function using information on an aggregation mode.

10. The device according to claim 9, wherein the network interface transmitting a content information request signal, and receiving content information corresponding to the content information request signal transmitted from the media server; and the control unit controlling the network interface to transmit a content information request signal to the media server according to a determining result, and to receive content information corresponding to the content information request signal.

11. The device according to claim 10, further comprising:
a display unit displaying information on the aggregation mode; and
a user interface receiving a user input to select the media server, wherein the user input comprises at last one of a user input to select a media server that is to transmit the service description request signal and a user input to select a media server that is to transmit the content information request signal.

12. The device according to claim 11, wherein the information on the aggregation mode comprises information on a current aggregation mode state;
when the current aggregation mode state is ON, the media server collects content information stored in the other servers;
when the current aggregation mode state is OFF, the media server does not collect content information stored in the other servers; and
when the current aggregation mode state is ON, the control unit controls the network interface to transmit the content information request signal to the media server.

13. The device according to claim 12, wherein, when the current aggregation mode state is OFF, the control unit controls the network interface to transmit an aggregation mode setting action including an aggregation mode state variable having the value of ON to the media server in order to change the current aggregation mode state into ON.

14. The device according to claim 12, wherein, when the current aggregation mode state is ON, the control unit controls the network interface to transmit an aggregation mode setting action including an aggregation mode state variable having the value of OFF to the media server in order to change the current aggregation mode state into OFF.

15. A control target device comprising:
a network interface receiving an aggregation mode obtaining action transmitted from a control device and a content information request signal and transmitting at least one of information on the aggregation mode and content information to the control device; and
a control unit collecting content information stored in other servers in the same network and controlling the network interface to transmit the collected content information to the control device in response to the content information request signal.

16. The device according to claim 15, wherein
the information on the aggregation mode comprises information on a current aggregation mode state; and
the control unit, when the current aggregation mode state is ON, collects content information stored in the other servers and, when the current aggregation mode state is OFF, does not collect the content information stored in the other servers.

17. The device according to claim 16, wherein
when the current aggregation mode state is ON, the network interface receives an aggregation mode setting action transmitted from the control device; and
the control unit changes the current aggregation mode state into OFF according to an aggregation mode state variable having the value of OFF in the aggregation mode setting action in order to stop collecting the content information stored in the other servers.

18. The device according to claim 16, wherein
when the current aggregation mode state is OFF, the network interface receives an aggregation mode setting action transmitted from the control device; and
the control unit changes the current aggregation mode state into ON according to an aggregation mode state variable having the value of ON in the aggregation mode setting action.
